(19) United States
(12) Patent Application Publication
(10) Pub. No.: US 2015/0039917 A1
(43) Pub. Date: Feb. 5, 2015

(54) INFORMATION PROCESSING DEVICE, ACTIVATION METHOD, AND COMPUTER PROGRAM PRODUCT

(71) Applicant: Kabushiki Kaisha Toshiba, Tokyo (JP)

(72) Inventor: Goichi Morikawa, Fussa-shi (JP)

(73) Assignee: Kabushiki Kaisha Toshiba, Tokyo (JP)

(21) Appl. No.: 14/283,655

(22) Filed: May 21, 2014

(30) Foreign Application Priority Data
Jul. 30, 2013 (JP) 2013-158110

(51) Int. Cl. G06F 1/32

(52) U.S. Cl. CPC G06F 1/32
USPC 713/310

(57) ABSTRACT

According to one embodiment, an information processing device includes a receiver, a search controller and a request transmitter. The receiver is configured to receive an activation request relative to a first device from a requesting device connected to a first network. The first device is connected to a second network. The search controller is configured to search for a second device in an activated state among a plurality of devices connected to the second network based on device state information indicative of a state of each of the devices. The request transmitter is configured to request the searched second device to transmit the activation request to the first device.

### CROSS-REFERENCE TO RELATED APPLICATIONS

This application is based upon and claims the benefit of priority from Japanese Patent Application No. 2013-158110, filed Jul. 30, 2013, the entire contents of which are incorporated herein by reference.

### FIELD

Embodiments described herein relate generally to an information processing device, an activation method, and a computer program product.

### BACKGROUND

In a single network segment, it is conventionally possible to activate a device such as a personal computer (PC) in the sleeping state with the use of a Wake-on-LAN (WOL) function. In such a conventional technique, a device resource can be accessed by activating a device such as a PC when necessary.

In such a conventional technique, it is desired to improve the convenience of users by allowing activation of a PC to be activated, without using special hardware, through a device that is located outside a network segment in which the PC to be activated is located, e.g. a device at an outside location.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary network configuration diagram of a communication system according to an embodiment;

FIG. 2 is an exemplary block diagram of a functional configuration of a server device in the embodiment;

FIG. 3 is an exemplary diagram of an example of a device control database (DB) in the embodiment;

FIG. 4 is an exemplary block diagram of a functional configuration of an information processing device in a second network in the embodiment; and

FIG. 5 is an exemplary sequence diagram of an activation processing flow in the embodiment.

### DETAILED DESCRIPTION

In general, according to one embodiment, an information processing device comprises a receiver, a search controller and a request transmitter. The receiver is configured to receive an activation request relative to a first device from a requesting device connected to a first network. The first device is connected to a second network. The search controller is configured to search for a second device in an activated state among a plurality of devices connected to the second network based on device state information indicative of a state of each of the devices. The request transmitter is configured to request the searched second device to transmit the activation request to the first device.

The following will describe an information processing device and an activation method of the embodiment in detail with reference to the enclosed drawings. A communication system of the embodiment has a configuration comprising an information processing device 200 connected to a first network 400 such as the Internet, a server device 100, a router 330, and a plurality of information processing devices 310a to 310n connected to the router 330 through a second network 350 such as a local area network (LAN).

In the embodiment, the information processing devices 310a to 310n are PCs, for example. However, they are not limited thereto. For example, devices such as portable terminals such as tablet terminals and cellular phones can be used as the information processing devices 310a to 310n. The information processing devices 310a to 310n have the activated state, the sleeping state, the stopped state, etc. Note that the information processing devices 310a to 310n are referred to as the information processing device 310 as a general term.

The information processing device 200 in the first network 400 transmits a WOL request that is a request for activating any of the information processing devices 310a to 310n in the second network 350, to the server device 100. The information processing device 200 is one example of a requesting device. The information processing device 200 in the first network 400 can be exemplified by devices such as PCs and portable terminals such as tablet terminals and cellular phones. However, it is not limited thereto.

The router 330 is a device that relays data flowing on the first network 400 to the second network 350.

When the server device 100 has received a WOL request relative to any of the information processing devices 310a to 310n in the second network 350 from the information processing device 200, it transmits a proxy transmission request of a WOL request to an information processing device to be activated, to an information processing device in the activated state among the information processing devices 310a to 310n in the second network 350. The server device 100 is one example of an information processing device.

As illustrated in FIG. 2, the server device 100 mainly comprises, as a functional configuration, a communication module 201, a controller 202, a search module 203, a proxy transmission request module 204, and a device control database 210 (hereinafter, referred to as the “device control DB 210”). The server device 100 has a hardware configuration of a normal computer comprising a central processing unit (CPU), a read only memory (ROM), a random access memory (RAM), a hard disk drive (HDD) device, a keyboard, and a mouse. However, the configuration is not limited thereto.

The communication module 201 communicates with a device connected to the first network 400. In the embodiment, the communication module 201 receives a WOL request that is an activation request relative to the information processing device 310 connected to the second network 350, from the information processing device 200 connected to the first network 400. Here, the WOL request comprises a MAC address of the information processing device 310 to be activated.

The communication module 201 communicates with devices in the second network 350 through the router 330. In the embodiment, the communication module 201 receives, at every certain period, device state information from each of the information processing devices 310 connected to the second network 350. The device state information is data indicating an activation state of each information processing device 310, and comprises an IP address of the information processing device 310, a MAC address of a network adapter of the information processing device 310, a port number of the router 330, and an activation state. The communication module 201 stores the received device state information in the device control DB 210.

The controller 202 controls the device control DB 210. The device control DB 210 is a database in which device state information received from each information processing device 310 in the second network 350 is registered, and is stored in a storage medium such as an HDD.

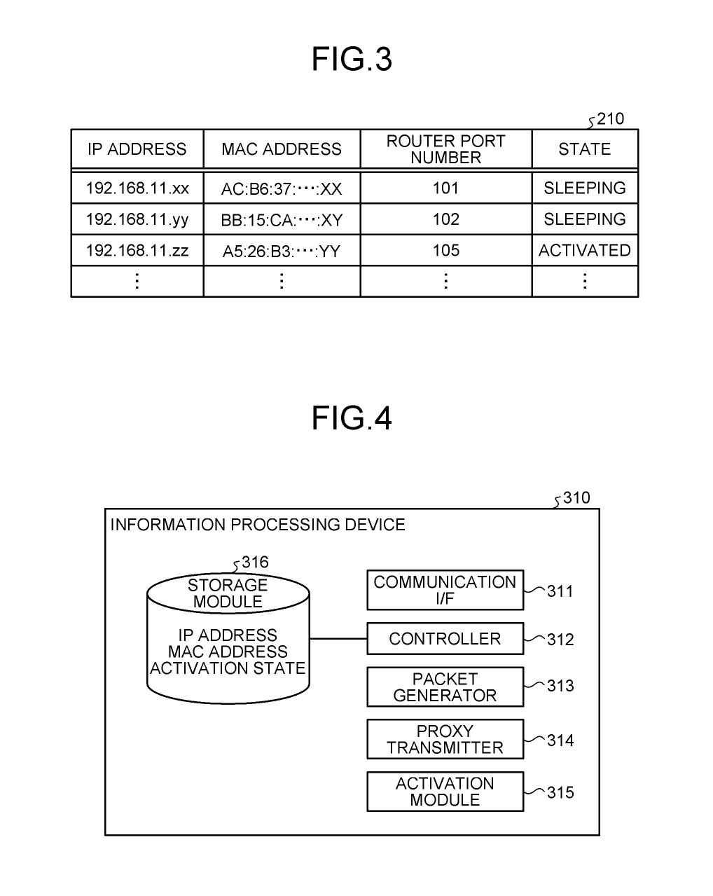

As illustrated in FIG. 3, the device control DB 210 stores device state information registered, as a record for each information processing device 310, comprising an IP address, a MAC address, a router port number, and a state in an associated manner. Here, the state indicates a current activation state of the information processing device 310, such as a sleeping state or an activated state.

Returning to FIG. 2, when a WOL request for activating the information processing device 310 in the second network 350 has been received from the information processing device 200 in the first network 400, the search module 203 refers to device state information registered in the device control DB 210, and searches the information processing device 310 in the activated state among the information processing devices 310 connected to the second network 350.

When a WOL request relative to the information processing device 310 in the second network 350 has been received from the information processing device 200 in the first network 400, and the information processing device 310 in the activated state has been searched in the second network 350, the proxy transmission request module 204 transmits a proxy transmission request to the searched information processing device 310 in the activated state. The proxy transmission request is a request for proxy transmission of the WOL request.

To be more specific, the proxy transmission request module 204 obtains an IP address of the information processing device 310 (information processing device in the activated state) searched by the search module 203 based on the device state information of such an information processing device 310 in the device control DB 210. Moreover, the proxy transmission request module 204 obtains a MAC address of the information processing device 310 to be activated that is specified by the WOL request received from the information processing device 200, based on the device state information of such an information processing device 310 in the device control DB 210. Then, the proxy transmission request module 204 generates a proxy transmission request comprising the MAC address of the information processing device 310 to be activated.

Here, the proxy transmission request comprises the designation of the MAC address of the information processing device 310 to be activated, and is a request for proxy transmission of broadcast transmission of a magic packet for activation within the second network 350. The proxy transmission request module 204 transmits the proxy transmission request while designating an IP address of the information processing device 310 in the activated state. In this manner, the proxy transmission request module 204 requests the information processing device 310 in the activated state to transmit the WOL request.

Next, the information processing device 310 in the second network 350 will be described. As illustrated in FIG. 4, the information processing device 310 in the second network 350 mainly comprises, as the functional configuration, a communication interface (I/F) 311, a controller 312, a packet generator 313, a proxy transmitter 314, an activation module 315, and a storage module 316.

Note that the information processing device 310 has a hardware configuration of a normal computer comprising a CPU, a ROM, a RAM, an HDD, a keyboard, and a mouse. However, the configuration is not limited thereto, and may be hardware configuration of devices such as portable terminals such as tablet terminals and cellular phones.

The communication I/F 311 is an interface of communication in the second network 350, and of communication to the first network 400 through the router 330. To be more specific, a network adaptor or other interfaces are applicable.

The storage module 316 is a storage medium such as an HDD and a memory that store an IP address, a MAC address, and an activation state of the information processing device. The controller 312 controls the IP address, the MAC address, and the activation state that are stored in the storage module 316. For example, when the IP address is changed, the controller 312 updates it. When the state of the information processing device is changed, the controller 312 updates the activation state. The controller 312 transmits, at every certain period, the IP address, the MAC address, and the activation state that are stored in the storage module 316 as device state information, to the server device 100 through the communication I/F 311 and the router 330, thereby performing state notification.

The packet generator 313 generates a packet to be transmitted through the communication I/F 311. In the embodiment, when the packet generator 313 has received a proxy transmission request from the server device 100, it obtains the MAC address of the information processing device 310 to be activated specified by the proxy transmission request, and generates a magic packet specifying the MAC address. Here, the magic packet is a packet that comprises, in its pay load, “FF:FF:FF:FF:FF:FF” (6 bytes) and sixteen repetitions of the MAC address of the information processing device 310 to be activated (6 bytes), for a total of 102 bytes of data.

The proxy transmitter 314 transmits, as a broadcast, the magic packet generated by the packet generator 313 to all devices in the second network 350.

The activation module 315 activates the information processing device from the sleeping state to the normal state. In particular, in the embodiment, when the magic packet has been received from a second information processing device 310 while the first information processing device is in the sleeping state, the activation module 315 compares the MAC address specified by the received magic packet with the MAC address held by the controller 312 of the first information processing device. Then, when both are the same, the activation module 315 activates the first information processing device from the sleeping state to the normal state. On the other hand, when the MAC address specified by the received magic packet is not the same as the MAC address held by the controller 312 of the first information processing device, the activation module 315 does not activate the first information processing device, and keeps it in the sleeping state.

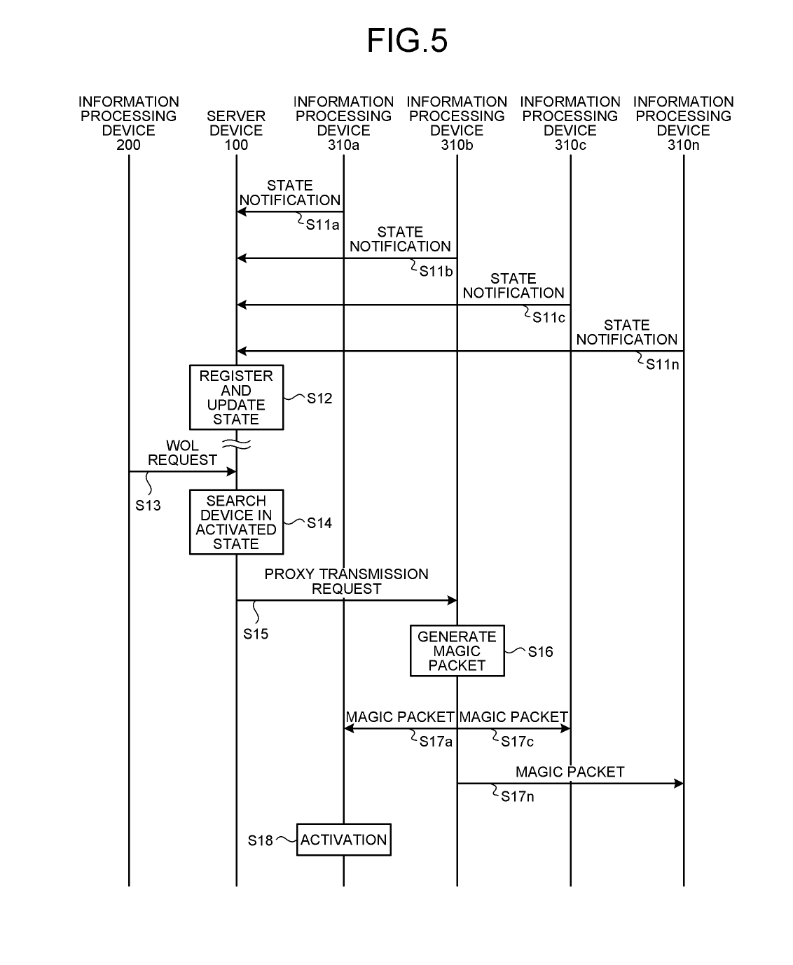

Next, the activation processing by the communication system of the embodiment configured in the above manner will be described with reference to FIG. 5.

The controller 312 of each of the information processing devices 310a to 310n in the second network 350 transmits, at every certain period, an IP address, a MAC address, and an activation state of the information processing device as device state information, to the server device 100 for state notification (S11a, S11b, S11b, and S11n). When the activation state of the information processing device 310 is changed (from the sleeping state to the activated state, for example), the controller 312 may be configured so that the device state information is transmitted to the server device 100 every time such a change is made.

The communication module 201 of the server device 100 registers and updates, in the device control DB 210, the device state information received from each information processing device 310 through state notification (S12).

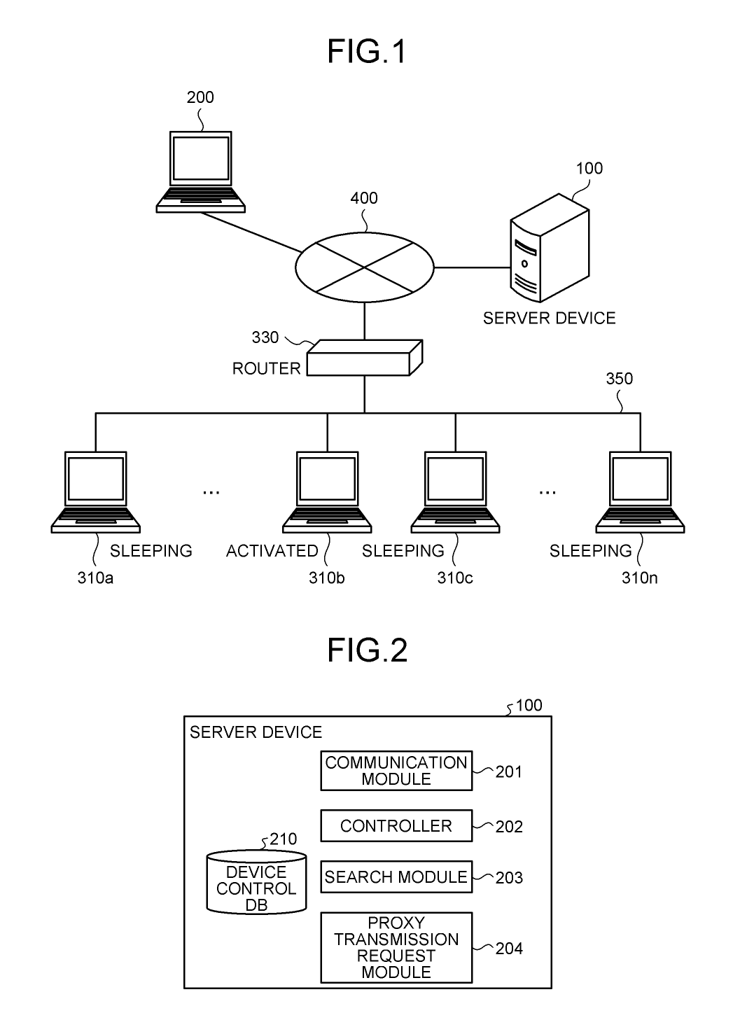

When the information processing device 200 in the first network 400 transmits a WOL request specifying a MAC address of the information processing device 310 to be activated to the server device 100, the communication module 201 of the server device 100 receives the WOL request (S13). Here, it is supposed that in the example of FIG. 1, the information processing device 310a in the sleeping state is specified as an object to be activated.

When the WOL request has been received, the search module 203 of the server device 100 refers to the device state information in the device control DB 210, and searches the information processing device 310 in the activated state among the information processing devices 310 in the second network 350 (S14). Here, it is supposed that in the example of FIG. 1, the information processing device 310b in the activated state has been searched. Then, the proxy transmission request module 204 transmits a proxy transmission request comprising the MAC address of the information processing device 310a to be activated, to the searched information processing device 310b (S15).

When the information processing device 310b has received the proxy transmission request, the packet generator 313 generates a magic packet comprising the MAC address of the information processing device 310a to be activated (S16). Then, the proxy transmitter 314 of the information processing device 310b performs broadcast transmission of the generated magic packet to all devices in the second network 350 (S17a, S17c, and S17n).

Each information processing device 310 receives the magic packet, and the activation module 315 compares the MAC address comprised in the magic packet with the MAC address of the information processing device. In the information processing device 310a, the MAC address comprised in the magic packet matches the MAC address of the first information processing device. Thus, the activation module 315 activates the first information processing device from the sleeping state to the normal state (S18). In the other information processing devices 310c and 310n, the MAC address comprised in the magic packet does not match the MAC address of the first information processing device. Thus, the activation module 315 does not activate the first information processing device, and keeps it in the sleeping state.

As described above, in the embodiment, when the server device 100 has received a WOL request that is an activation request relative to the information processing device 310 in the second network 350, it searches the information processing device 310 in the activated state in the second network 350, and transmits a proxy transmission request to the searched information processing device 310 in the activated state to request it to perform proxy transmission of the activation request to the information processing device 310 to be activated. Then, the information processing device 310 in the activated state in the second network 350 that has received the proxy transmission request generates a magic packet comprising the MAC address of the information processing device 310 to be activated, and performs broadcast transmission of the magic packet in the second network 350. In this manner, in the embodiment, it is possible to activate, through a device at an outside location such as the information processing device 200 in the first network 400, the information processing device 310 to be activated in the second network 350 such as in a home without using any special hardware, thus improving the convenience for users.

That is, conventionally, it is possible to activate, using a WOL function, a device such as an information processing device in the sleeping state in a single network segment. Here, in the WOL function, a WOL packet employs a technique of Layer 2 (data link layer) of the OSI reference protocol. Thus, the device performing broadcast transmission of a WOL magic packet needs to be located in a network segment in which an information processing device to be activated is located. When the device performing broadcast transmission is not located in the same network segment, the PC to be activated cannot be activated. Thus, it is difficult to activate the information processing device through the device at an outside location.

In order to activate the information processing device from an outside location, a WOL using a universal plug and play (UPnP) function of a router can be used. However, the preparation of a router supporting UPnP is necessary.

Even when a router supporting UPnP is used, the WOL using the UPnP function is difficult to achieve if the router has a multistage configuration. In case of such a multistage configuration, a user himself/herself needs to set a port forwarding function of the router, and it takes a lot of time to establish the environment so that the WOL functions.

There exists hardware that performs proxy transmission of a WOL magic packet in a single network segment. However, the preparation of special hardware is necessary, which lacks the convenience for users.

Thus, in the embodiment, with the adoption of the configuration described above, an application allowing proxy transmission is installed and registered in the existing information processing device 310, only by which the information processing device 310 can be a relay for a WOL request. Therefore, the embodiment enables a user to activate the information processing device 310 to be activated in the second network 350 such as in a home through a device at an outside location such as the information processing device 200 in the outside first network 400 without any need for preparing special hardware, which improves the convenience for the user.

An activation control program executed in the server device 100 of the embodiment is recorded, as a file whose format is installable or executable, in a computer readable recording medium such as a compact disk read-only memory (CD-ROM), a flexible disk (FD), a compact disk recordable (CD-R), and a digital versatile disk (DVD), and then provided as a computer program product.

Moreover, the activation control program executed in the server device 100 of the embodiment may be stored in a computer connected to a network such as the Internet, and then provided as a computer program product by download thereof through the network. Alternatively, the activation control program executed in the server device 100 of the embodiment may be provided or distributed through a network such as the Internet.

Moreover, the activation control program executed in the server device 100 of the embodiment may be preliminarily embedded and provided as a computer program product in a ROM, for example.

The activation control program executed in the server device 100 of the embodiment is of a module configuration comprising the modules described above (communication module 201, controller 202, search module 203, proxy transmission request module 204). The CPU of the server device of the embodiment reads out the activation control program from the recording medium, and executes it, whereby the modules described above are loaded on the RAM, and the communication module 201, the controller 202, the search module 203, and the proxy transmission request module 204 are generated on the RAM.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising:
a receiver configured to receive an activation request relative to a first device from a requesting device connected to a first network, the first device connected to a second network;
a search controller configured to search for a second device in an activated state among a plurality of devices connected to the second network based on device state information indicative of a state of each of the devices; and
a request transmitter configured to request the searched second device to transmit the activation request to the first device.

2. The information processing device of claim 1, further comprising storage, wherein
the receiver is configured to further receive the device state information from each of the devices connected to the second network, and to store the received device state information in the storage so that the device state information is associated with identification information of each of the devices.

3. The information processing device of claim 1, wherein the request transmitter is configured to request the second device to perform broadcast transmission, within the second network, of a packet for the activation request that specifies the identification information of the first device.

4. An activation method, comprising:
by an information processing device,
receiving an activation request relative to a first device from a requesting device connected to a first network, the first device connected to a second network;
searching for a second device in an activated state among a plurality of devices connected to the second network based on device state information indicative of a state of each of the devices; and
requesting the searched second device to transmit the activation request to the first device.

5. The activation method of claim 4, further comprising:
by the second device,
generating, when receiving a proxy transmission request corresponding to the activation request, a magic packet for the activation request that specifies identification information of the first device; and
performing broadcast transmission of the packet within the second network.

6. A computer program product having a non-transitory computer readable medium including programmed instructions, wherein the instructions, when executed by a computer, cause the computer to perform:
receiving an activation request relative to a first device from a requesting device connected to a first network, the first device connected to a second network;
searching for a second device in an activated state among a plurality of devices connected to the second network based on device state information indicative of a state of each of the devices; and
requesting the searched second device to transmit the activation request to the first device.
